(19) United States
(12) Patent Application Publication
(10) Pub. No.: US 2025/0392902 A1
(43) Pub. Date: Dec. 25, 2025

(54) METHOD AND APPARATUS FOR TRANSMITTING CAPABILITY INFORMATION OR CONFIGURATION INFORMATION, AND READABLE STORAGE MEDIUM

(71) Applicant: Beijing Xiaomi Mobile Software Co., Ltd., Beijing (CN)

(72) Inventor: Juan ZHANG, Beijing (CN)

(21) Appl. No.: 18/878,840

(22) PCT Filed: Jun. 29, 2022
(86) PCT No.: PCT/CN2022/102407

§ 371 Date: Dec. 24, 2024

(51) Int. Cl. H04W 8/22; H04L 27/26; H04W 72/0453

(52) U.S. Cl. CPC H04W 8/22; H04L 27/2605; H04W 72/0453

(57) ABSTRACT

A method for transceiving indication information, where the indication information includes user equipment capability information, the method includes: sending user equipment capability information to a network device by user equipment, where the user equipment capability information is used indicatingto indicate whether to support a first capability, the first capability is an ability of a user equipment-side channel bandwidth to support a first guard bandwidth and also to support a second guard bandwidth, and the first guard bandwidth is greater than the second guard bandwidth.

### CROSS-REFERENCE

The present application is a U.S. National Stage of International Application No. PCT/CN2022/102407, filed on Jun. 29, 2022, the contents of which are incorporated herein by reference in their entirety for all purposes.

### BACKGROUND OF THE INVENTION

In the related art, a guard band is determined according to a difference value between a channel bandwidth and a transmission bandwidth, so a situation that a minimum guard band of 30 MHz CBW is greater than a minimum guard band of 40 MHz CBW occurs. When user equipment accesses a system bandwidth of 40 MHz in a channel bandwidth of 30 MHz within a frequency band of N28, if carrier edge extension exceeds a bandwidth lower limit (758 MHz), the user equipment may stop accessing a network due to failure in reconfiguration of a radio resource control (RRC).

### SUMMARY OF THE INVENTION

The disclosure provides a method and apparatus for transceiving indication information, and a readable storage medium.

In a first aspect, a method for transceiving indication information is provided, performed by user equipment, where the indication information includes user equipment capability information, the method includes:
sending the user equipment capability information to a network device, where the user equipment capability information is used to indicate whether to support a first capability, the first capability is an ability of a user equipment-side channel bandwidth to support a first guard bandwidth and also to support a second guard bandwidth, and the first guard bandwidth is greater than the second guard bandwidth.

In a second aspect, a method for transceiving indication information is provided, performed by a network device, the method including:
receiving user equipment capability information sent by user equipment, where the user equipment capability information is used to indicate whether to support a first capability, the first capability is an ability of a user equipment-side channel bandwidth to support a first guard bandwidth and also to support a second guard bandwidth, and the first guard bandwidth is greater than the second guard bandwidth.

In a third aspect, a communication apparatus is provided and includes one or more processors and a memory, where
the memory is configured to store a computer program; and
the one or more processors are configured to execute the computer program to implement following steps of:
sending the user equipment capability information to a network device, wherein the user equipment capability information is used to indicate whether to support a first capability, the first capability is an ability of a user equipment-side channel bandwidth to support a first guard bandwidth and also to support a second guard bandwidth, and the first guard bandwidth is greater than the second guard bandwidth.

In a fourth aspect, a communication apparatus is provided and includes one or more processors and a memory, where
the memory is configured to store a computer program; and
the one or more processors are configured to execute the computer program to implement the second aspect.

In a fifth aspect, a non-transitory computer-readable storage medium is provided, where the non-transitory computer-readable storage medium stores an instruction which causes, when called and executed on one or more computers, the one or more computers to implement the first aspect.

In a sixth aspect, a non-transitory computer-readable storage medium is provided, where the non-transitory computer-readable storage medium stores an instruction which causes, when called and executed on one or more computers, the one or more computers to implement the second aspect.

It is to be understood that the above general description and the following detailed description are merely examples and explanatory instead of limiting the disclosure.

### BRIEF DESCRIPTION OF DRAWINGS

FIG. 1 is a schematic architectural diagram of a wireless communication system provided by an example of the disclosure.

FIG. 2 is a flowchart of a method for transceiving user equipment capability information shown according to an example.

FIG. 3 is a flowchart of a method for sending user equipment capability information shown according to an example.

FIG. 4 is a flowchart of a method for receiving user equipment capability information shown according to an example.

FIG. 5 is a flowchart of a method for transceiving configuration information shown according to an example.

FIG. 6 is a schematic diagram of a channel bandwidth shown according to an example.

FIG. 7 is a flowchart of a method for sending configuration information shown according to an example.

FIG. 8 is a flowchart of a method for receiving configuration information shown according to an example.

FIG. 9 is a structural diagram of an apparatus for sending user equipment capability information shown according to an example.

FIG. 10 is a structural diagram of an apparatus for receiving configuration information shown according to an example.

FIG. 11 is a structural diagram of an apparatus for transceiving capability information or configuration information shown according to an example.

FIG. 12 is a structural diagram of an apparatus for receiving user equipment capability information shown according to an example.

FIG. 13 is a structural diagram of an apparatus for sending configuration information shown according to an example.

FIG. 14 is a structural diagram of an apparatus for transceiving capability information or configuration information shown according to an example.

### DETAILED DESCRIPTION OF THE INVENTION

The examples of the disclosure are further described with reference to the accompanying drawings and specific implementations.

The examples will be described in detail here, and their instances are represented in the accompanying drawings. Unless otherwise indicated, when the following description refers to the accompanying drawings, the same number in the different accompanying drawings represents the same or similar elements. Implementations described in the following examples do not represent all implementations consistent with the examples of the disclosure. Rather, they are merely examples of an apparatus and method consistent with some aspects of the disclosure as detailed in the appended claims.

Terms used in the examples of the disclosure are merely intended to describe specific examples but not to limit the examples of the disclosure. A singular form “a/an” and “said” used in the examples and the appended claims of the disclosure is also intended to include a plural form unless other meanings are indicated clearly in the context. It is to be further understood that a term “and/or” used here refers to and contains any one or all possible combinations of one or a plurality of associated listed items.

It is to be understood that various information, possibly described by using terms such as first, second and third in the examples of the disclosure, is not limited to these terms. These terms are merely used for distinguishing the same type of information. For example, without departing from the scope of the examples of the disclosure, first information may also be called second information, and similarly, the second information may also be called the first information. Depending on the context, words such as “if” and “in a case that” used here may be construed as “when . . . ”, or “while . . . ” or “in response to determining”.

The disclosure relates to the technical field of wireless communications, in particular to a method and apparatus for transceiving capability information or configuration information, and a readable storage medium.

The examples of the disclosure are described in detail below, instances of the examples are shown in the accompanying drawings, and the same or similar reference numerals represent the same or similar elements all the time. The examples described with reference to the accompanying drawings below are examples and are intended to explain the disclosure but are not understood as a limitation on the disclosure.

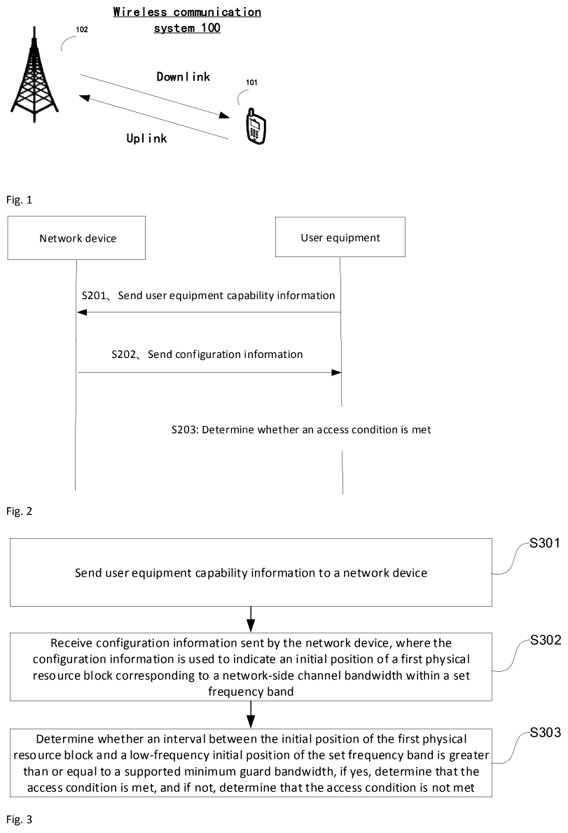

As shown in FIG. 1, a method for transceiving capability information or configuration information provided by an example of the disclosure may be applied to a wireless communication system 100. The wireless communication system may include but is not limited to a network device 101 and user equipment 102. The user equipment 102 is configured to support carrier aggregation and may be connected to a plurality of carrier units of the network device 101, and the carrier units include one main carrier unit and one or more auxiliary carrier units.

It is to be understood that the above wireless communication system 100 may be applied not only to a low-frequency scene, but also to a high-frequency scene. Application scenes of the wireless communication system 100 include but are not limited to a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th generation (5G) system, a new radio (NR) communication system or a future evolved public land mobile network (PLMN) system or the like.

The user equipment 102 shown above may be user equipment (UE), a terminal, an access terminal, a terminal unit, a terminal station, a mobile station (MS), a remote station, a remote terminal, a mobile terminal, a wireless communication device, a terminal agent or user equipment or the like. The user equipment 102 may have a wireless transceiving function and can communicate (such as wireless communication) with one or more network devices 101 of one or more communication systems and receive a network service provided by the network device 101. The network device 101 here includes but is not limited to a base station illustrated.

The user equipment 102 may be a cell phone, a cordless telephone, a session initiation protocol (SIP) telephone, a wireless local loop (WLL) station, a personal digital assistant (PDA) device, a handheld device with a wireless communication function, a computing device or another processing device connected to a radio modem, a vehicle-mounted device, a wearable device, user equipment in the future 5G network or user equipment in the future evolved PLMN network or the like.

The network device 101 may be the access network device (or called an access network site). The access network device refers to a device providing a network access function, such as a radio access network (RAN) base station, etc. The network device may include a base station (BS) device or include a base station device, a radio resource management device for controlling the base station device and the like. The network device may further include a relay station (relay device), an access point, a base station in the future 5G network, a base station in the future evolved PLMN network, an NR base station or the like. The network device may be a wearable device or a vehicle-mounted device. The network device may also be a communication chip with a communication module.

For example, the network device 101 includes but is not limited to: a next generation base station (gnodeB (gNB)) in 5G, evolved node B (eNB) in the LTE system, a radio network controller (RNC), node B (NB) in a WCDMA system, a wireless controller under the CRAN system, a base station controller (BSC), a base transceiver station (BTS) in a GSM system or a CDMA system, a home base station (for example, home evolved nodeB or home node B (HNB)), a baseband unit (BBU), a transmitting and receiving point (TRP), a transmitting point (TP), a mobile switching center or the like.

The user equipment has the following two radio frequency implementation manners for a frequency band n28:
a first manner: a whole n28 45 MHz frequency spectrum is covered through a wide duplexer.
a second manner: the n28 45 MHz frequency spectrum is covered through two 30 MHz duplexers.

A user equipment side supports a channel bandwidth of at most 30 MHz, and gNB supports a channel bandwidth of at most 40 MHz.

In actual network deployment, gNB adopts a constant bandwidth (CBW) of 40 MHz, and in view of the capability of the UE, a dedicated constant bandwidth of 30 MHz may be adopted. The dedicated bandwidth of 30 MHz is limited as 703-733/758-788 or 718-748/768-798 MHz. In an example, an RB initial point of the UE may be aligned to an RB initial point of gNB. As shown in FIG. 6, A low-frequency guard bandwidth and a high-frequency guard bandwidth of the network-side channel bandwidth are the same and are 552.5 KHz, and a low-frequency guard bandwidth and a high-frequency guard bandwidth of the user equipment-side channel bandwidth are the same and are 592.5 KHz. A blank region of 15 KHz is included at a carrier-frequency center of the network-side channel bandwidth, and a blank region of 15 KHz is also included at a carrier-frequency center of the user equipment-side channel bandwidth.

In some implementations, a low-frequency guard bandwidth and high-frequency guard bandwidth of the same channel bandwidth are the same, and a guard band is determined according to a difference value between the channel bandwidth and a transmission bandwidth, for example,

when subcarrier spacing (SCS) is 15 KHz, a maximum transmission bandwidth of 40 MHz CBW of gNB is configured as 216 PRB, and a minimum guard band is 552.5 KHz.

When subcarrier spacing (SCS) is 15 KHz, a maximum transmission bandwidth of 30 MHz CBW of the UE is configured as 160 PRB, and a minimum guard band is 592.5 KHz.

Thus, a situation that a minimum guard band of the 30 MHz CBW is greater than a minimum guard band of the 40 MHz CBW occurs.

In view of this, an example of the disclosure provides a method for transceiving user equipment capability information. FIG. 2 is a flowchart of a method for transceiving user equipment capability information shown according to an example. As shown in FIG. 2, the method includes steps S201 to S203.

Step S201: user equipment capability information is sent to a network device by user equipment.

The user equipment capability information is used to indicate whether to support a first capability, the first capability is an ability of a user equipment-side channel bandwidth to support a first guard bandwidth and also to support a second guard bandwidth, and the first guard bandwidth is greater than the second guard bandwidth.

In some possible implementations, a method for sending the user equipment capability information to the network device by the user equipment is: sending the user equipment capability information including a radio frequency parameter to the network device, where the radio frequency parameter includes an information field for indicating whether to support a transmission based on a supported narrow guard band (supported narrow GB) width, and the information field is used to indicate whether to support the first capability.

In some possible implementations, the second guard bandwidth is equal to a minimum guard bandwidth of a network-side channel bandwidth, and the user equipment-side channel bandwidth is less than the network-side channel bandwidth.

In some possible examples, the first guard bandwidth and the second guard bandwidth are low-frequency guard bandwidths of the user equipment-side channel bandwidth.

Step S202: configuration information is sent to the user equipment by the network device, where the configuration information is used to indicate an initial position of a first physical resource block corresponding to a network-side channel bandwidth within a set frequency band.

Step S203: whether an interval between the initial position of the first physical resource block and a low-frequency initial position of the set frequency band is greater than or equal to a supported minimum guard bandwidth is determined by the user equipment, if yes, it is determined that the access condition is met, and if not, it is determined that the access condition is not met.

A description is made below through an example.

This example is applied to a downlink frequency band of 758 MHz to 788 MHz in a frequency band n28.

When the SCS is 15 KHz, the user equipment-side channel bandwidth is 30 MHz, a maximum transmission bandwidth is configured as 160 PRB, and a first guard bandwidth is 592.5 KHz. The network-side channel bandwidth is 40 MHz, a maximum transmission bandwidth is configured as 216 PRB, and a minimum guard bandwidth is 552.5 KHz.

The UE supports the first capability, supporting the first guard bandwidth and also supporting the second guard bandwidth, namely, supporting the first guard bandwidth of 592.5 KHz and also supporting the second guard bandwidth of 552.5 KHz.

The user equipment capability information is sent to the network device by the user equipment, where the user equipment capability information indicates to support the first capability.

The configuration information is sent to the user equipment by the network device, and the initial position of the first physical resource block corresponding to the network-side channel bandwidth within the set frequency band is indicated as 758 MHz+552.5 KHz.

The interval between the initial position of the first physical resource block and the low-frequency initial position of the set frequency band is determined as 552.5 KHz by the user equipment, it is determined that the interval is equal to the supported minimum guard bandwidth, namely, the second guard bandwidth of 552.5 KHz, and thus it is determined that the access condition is met.

In the example of the disclosure, the user equipment capability information is reported to the network device by the user equipment, so as to indicate that the user equipment within the user equipment-side channel bandwidth may also support another smaller guard bandwidth while supporting a larger guard bandwidth, and dependence of the guard bandwidth on the difference value between the channel bandwidth and the transmission bandwidth is lifted, so that a situation of a failure in accessing the user equipment caused by the fact that a guard bandwidth of the user equipment-side channel bandwidth is greater than the guard bandwidth of the network-side channel bandwidth when the user equipment accesses a network within the set frequency band is avoided.

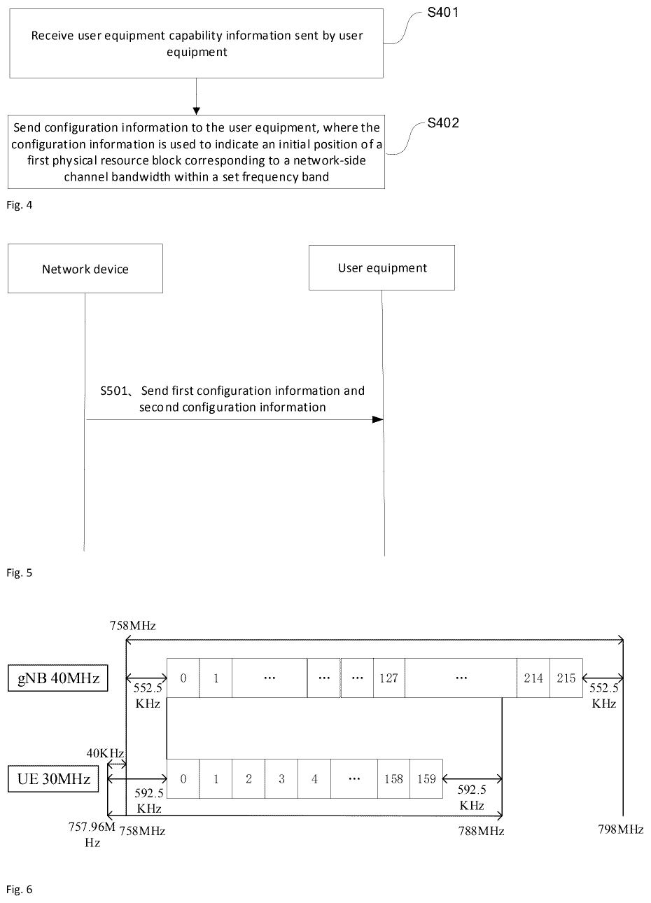

An example of the disclosure provides a method for sending user equipment capability information, performed by user equipment. FIG. 3 is a flowchart of a method for sending user equipment capability information shown according to an example. As shown in FIG. 3, the method includes steps S301 to S303.

Step S301: the user equipment capability information is sent to a network device.

The user equipment capability information is used to indicate whether to support a first capability, the first capability is an ability of a user equipment-side channel bandwidth to support a first guard bandwidth and also to support a second guard bandwidth, and the first guard bandwidth is greater than the second guard bandwidth.

In some possible implementations, a method for sending the user equipment capability information to the network device by the user equipment is: sending the user equipment capability information including a radio frequency parameter to the network device, where the radio frequency parameter includes an information field for indicating whether to support a transmission based on an supported narrow guard band (supported narrow GB) width, and the information field is used to indicate whether to support the first capability.

In some possible implementations, the second guard bandwidth is equal to a minimum guard bandwidth of a network-side channel bandwidth, and the user equipment-side channel bandwidth is less than the network-side channel bandwidth.

In some possible examples, the first guard bandwidth and the second guard bandwidth are low-frequency guard bandwidths of the user equipment-side channel bandwidth.

Step S302: configuration information sent by the network device is received, where the configuration information is used to indicate an initial position of a first physical resource block corresponding to a network-side channel bandwidth within a set frequency band.

Step S303: whether an interval between the initial position of the first physical resource block and a low-frequency initial position of the set frequency band is greater than or equal to a supported minimum guard bandwidth is determined, if yes, it is determined that the access condition is met, and if not, it is determined that the access condition is not met.

An example of the disclosure provides a method for receiving user equipment capability information, performed by a network device. FIG. 4 is a flowchart of a method for receiving user equipment capability information shown according to an example. As shown in FIG. 4, the method includes steps S401 to S402.

Step S401: user equipment capability information sent by user equipment is received.

The user equipment capability information is used to indicate whether to support a first capability, the first capability is an ability of a user equipment-side channel bandwidth to support a first guard bandwidth and also to support a second guard bandwidth, and the first guard bandwidth is greater than the second guard bandwidth.

In some possible implementations, a method for receiving the user equipment capability information sent by the user equipment is: receiving the user equipment capability information including a radio frequency parameter sent by the user equipment, where the radio frequency parameter includes an information field for indicating whether to support a transmission based on an supported narrow guard band (supported narrow GB) width, and the information field is used to indicate whether to support the first capability.

In some possible implementations, the second guard bandwidth is equal to a minimum guard bandwidth of a network-side channel bandwidth, and the user equipment-side channel bandwidth is less than the network-side channel bandwidth.

In some possible examples, the first guard bandwidth and the second guard bandwidth are low-frequency guard bandwidths of the user equipment-side channel bandwidth.

Step S402: configuration information is sent to the user equipment, where the configuration information is used to indicate an initial position of a first physical resource block corresponding to a network-side channel bandwidth within a set frequency band.

In view of a self-checking action by the UE during an RRC connection, when it is detected that a carrier edge extension exceeds a lower limit of a to-be-accessed frequency band, for example, during accessing the network-side channel bandwidth of 40 MHz in a frequency band n28, there may occur a situation of stopping accessing a network due to failure in RRC reconfiguration as well as a situation of maintaining an RRC_CONNECTED state but reducing performance (especially, at the lowest PRB of the carrier edge).

An example of the disclosure provides a method for transceiving configuration information. FIG. 5 is a flowchart of a method for transceiving configuration information shown according to an example. As shown in FIG. 5, the method includes step S501.

Step S501: first configuration information and second configuration information are sent to user equipment by a network device.

The first configuration information is used to indicate an offset, the offset is an offset of an initial position of a low-frequency guard band of a network-side channel bandwidth, and an offset direction corresponding to the offset is a direction from a low frequency to a high frequency; and

the second configuration information is used to indicate an initial position of a first physical resource block corresponding to the network-side channel bandwidth within a set frequency band, and the initial position is determined according to the offset.

In some possible examples, the offset is a first value, and the first value is an integer multiple of granularity of a channel raster.

For example, the granularity of the channel raster is 100 KHz, so the offset is an integer multiple of 100 KHz, so as to guarantee that a carrier center is aligned to the channel raster. For example, the offset is 100 KHz, 200 KHz, 300 KHz or other values.

In an example, as shown in FIG. 6, the set frequency band is a downlink frequency band of 758 MHz to 788 MHz in an n28 frequency band, a network-side channel band is 40 MHZ, a low-frequency initial position is 758 MHz, the low-frequency guard band is 552.5 KHz, when the offset of the initial position of the low-frequency guard band is 100 KHz, the initial position of the first physical resource block in the network-side channel band also offsets by 100 KHz in a high-frequency direction correspondingly, and then the initial position of the first physical resource block in the network-side channel band is 758 MHz+552.5 KHz+100 KHz.

In some possible examples, the network device does not schedule at least one of final physical resource blocks within the network-side channel band.

For example, the set frequency band is a downlink frequency band of 758 MHz to 788 MHz in an n28 frequency band, the network-side channel band is a channel bandwidth of 40 MHZ, 216 physical resource blocks are included in the network-side channel band, and when the offset is 100 KHz and the network device is under performing network scheduling, the last physical resource block is not scheduled.

In some possible examples, the offset is a second value, the second value is a difference value between a guard bandwidth of a user equipment-side channel bandwidth and a guard bandwidth of the network-side channel bandwidth, the network-side channel bandwidth is greater than the user equipment-side channel bandwidth, and the guard bandwidth of the network-side channel bandwidth is less than the guard bandwidth of the user equipment-side channel bandwidth.

For example, the set frequency band is an n28 frequency band, the network-side channel band is a channel bandwidth of 40 MHz, a guard bandwidth of the network-side channel band is 552.5 KHz, a user equipment-side channel band is a channel bandwidth of 30 MHz, a guard bandwidth of a user equipment-side channel is 592.5 KHz, a difference value between the guard bandwidth of the user equipment-side channel band and the guard bandwidth of the network-side channel band is 40 KHz, so the offset is 40 KHz, and thus the low-frequency guard band of the network-side channel band offsets and then keeps consistent with a low-frequency guard band of a user equipment-side channel band.

Step S502: whether an interval between the initial position of the first physical resource block and a low-frequency initial position of the set frequency band is greater than or equal to a supported minimum guard bandwidth is determined, if yes, it is determined that the access condition is met, and if not, it is determined that the access condition is not met.

In an example, as shown in FIG. 6, the set frequency band is a downlink frequency band of 758 MHz to 788 MHz in an n28 frequency band, a network-side channel band is 40 MHz, a low-frequency initial position is 758 MHz, the low-frequency guard band is 552.5 KHz, when the offset of the initial position of the low-frequency guard band is 100 KHz, the initial position of the first physical resource block in the network-side channel band also offsets by 100 KHz in a high-frequency direction correspondingly, and then the initial position of the first physical resource block in the network-side channel band is 758 MHz+552.5 KHz+100 KHz.

The interval between the initial position of the first physical resource block in the network-side channel band and the low-frequency initial position of the set frequency band is determined as 652.5 KHz by the user equipment, it is determined that the interval is greater than the minimum guard bandwidth supported by the user equipment, namely, 592.5 KHz, and thus it is determined that the access condition is met.

In another example, the set frequency band is a downlink frequency band of 758 MHz to 788 MHz in the n28 frequency band, the network-side channel band is 40 MHZ, the low-frequency initial position is 758 MHz, the low-frequency guard band is 552.5 KHz, when the offset of the initial position of the low-frequency guard band is 40 KHz, the initial position of the first physical resource block in the network-side channel band also offsets by 40 KHz in the high-frequency direction correspondingly, and then the initial position of the first physical resource block in the network-side channel band is 758 MHz+552.5 KHz+40 KHz.

The interval between the initial position of the first physical resource block in the network-side channel band and the low-frequency initial position of the set frequency band is determined as 592.5 KHz by the user equipment, it is determined that the interval is equal to the minimum guard bandwidth supported by the user equipment, namely, 592.5 KHz, and thus it is determined that the access condition is met.

In the example of the disclosure, by making an initial position of the guard band of the network-side channel bandwidth and the initial position of the first physical resource block of the network-side channel bandwidth offset in a high-frequency direction, a problem of a failure in accessing the user equipment or reduction of connection performance caused by the fact that the guard bandwidth of the user equipment-side channel bandwidth is greater than the guard bandwidth of the network-side channel bandwidth when the user equipment accesses a network within a set frequency band is avoided.

An example of the disclosure provides a method for sending configuration information, performed by a network device. FIG. 7 is a flowchart of a method for sending configuration information shown according to an example. As shown in FIG. 7, the method includes step S701.

Step S701: first configuration information and second configuration information are sent to user equipment.

The first configuration information is used to indicate an offset, the offset is an offset of an initial position of a low-frequency guard band of a network-side channel bandwidth, and an offset direction corresponding to the offset is a direction from a low frequency to a high frequency; and
the second configuration information is used to indicate an initial position of a first physical resource block corresponding to the network-side channel bandwidth within a set frequency band, and the initial position is determined according to the offset.

In some possible examples, the offset is a first value, and the first value is an integer multiple of granularity of a channel raster.

For example, the granularity of the channel raster is 100 KHz, so the offset is an integer multiple of 100 KHz, so as to guarantee that a carrier center is aligned to the channel raster. For example, the offset is 100 KHz, 200 KHz, 300 KHz or other values.

In an example, as shown in FIG. 6, the set frequency band is a downlink frequency band of 758 MHz to 788 MHz in an n28 frequency band, a network-side channel band is 40 MHZ, a low-frequency initial position is 758 MHz, the low-frequency guard band is 552.5 KHz, when the offset of the initial position of the low-frequency guard band is 100 KHz, the initial position of the first physical resource block in the network-side channel band also offsets by 100 KHz in a high-frequency direction correspondingly, and then the initial position of the first physical resource block in the network-side channel band is 758 MHz+552.5 KHz+100 KHz.

In some possible examples, the network device does not schedule at least one of final physical resource blocks within the network-side channel band.

For example, the set frequency band is a downlink frequency band of 758 MHz to 788 MHz in an n28 frequency band, the network-side channel band is a channel bandwidth of 40 MHz, 216 physical resource blocks are included in the network-side channel band, and when the offset is 100 KHz and the network device is under performing network scheduling, the last physical resource block is not scheduled.

In some possible examples, the offset is a second value, the second value is a difference value between a guard bandwidth of a user equipment-side channel bandwidth and a guard bandwidth of the network-side channel bandwidth, the network-side channel bandwidth is greater than the user equipment-side channel bandwidth, and the guard bandwidth of the network-side channel bandwidth is less than the guard bandwidth of the user equipment-side channel bandwidth.

For example, the set frequency band is an n28 frequency band, the network-side channel band is a channel bandwidth of 40 MHz, a guard bandwidth of the network-side channel band is 552.5 KHz, a user equipment-side channel band is a channel bandwidth of 30 MHz, a guard bandwidth of a user equipment-side channel is 592.5 KHz, a difference value between the guard bandwidth of the user equipment-side channel band and the guard bandwidth of the network-side channel band is 40 KHz, so the offset is 40 KHz, and thus the low-frequency guard band of the network-side channel band offsets and then keeps consistent with a low-frequency guard band of a user equipment-side channel band.

An example of the disclosure provides a method for receiving configuration information, performed by user equipment. FIG. 8 is a flowchart of a method for receiving configuration information shown according to an example. As shown in FIG. 8, the method includes steps S801 to S802.

Step S801: first configuration information and second configuration information sent by a network device are received.

The first configuration information is used to indicate an offset, the offset is an offset of an initial position of a low-frequency guard band of a network-side channel bandwidth, and an offset direction corresponding to the offset is a direction from a low frequency to a high frequency; and

the second configuration information is used to indicate an initial position of a first physical resource block corresponding to the network-side channel bandwidth within a set frequency band, and the initial position is determined according to the offset.

In some possible examples, the offset is a first value, and the first value is an integer multiple of granularity of a channel raster.

For example, the granularity of the channel raster is 100 KHz, so the offset is an integer multiple of 100 KHz, so as to guarantee that a carrier center is aligned to the channel raster. For example, the offset is 100 KHz, 200 KHz, 300 KHz or other values.

In an example, as shown in FIG. 6, the set frequency band is a downlink frequency band of 758 MHz to 788 MHz in an n28 frequency band, a network-side channel band is 40 MHZ, a low-frequency initial position is 758 MHz, the low-frequency guard band is 552.5 KHz, when the offset of the initial position of the low-frequency guard band is 100 KHz, the initial position of the first physical resource block in the network-side channel band also offsets by 100 KHz in a high-frequency direction correspondingly, and then the initial position of the first physical resource block in the network-side channel band is 758 MHz+552.5 KHz+100 KHz.

In some possible examples, the network device does not schedule at least one of final physical resource blocks within the network-side channel band.

For example, the set frequency band is a downlink frequency band of 758 MHz to 788 MHz in an n28 frequency band, the network-side channel band is a channel bandwidth of 40 MHz, 216 physical resource blocks are included in the network-side channel band, and when the offset is 100 KHz and the network device is under performing network scheduling, the last physical resource block is not scheduled.

In some possible examples, the offset is a second value, the second value is a difference value between a guard bandwidth of a user equipment-side channel bandwidth and a guard bandwidth of the network-side channel bandwidth, the network-side channel bandwidth is greater than the user equipment-side channel bandwidth, and the guard bandwidth of the network-side channel bandwidth is less than the guard bandwidth of the user equipment-side channel bandwidth.

For example, the set frequency band is an n28 frequency band, the network-side channel band is a channel bandwidth of 40 MHz, a guard bandwidth of the network-side channel band is 552.5 KHz, a user equipment-side channel band is a channel bandwidth of 30 MHz, a guard bandwidth of a user equipment-side channel is 592.5 KHz, a difference value between the guard bandwidth of the user equipment-side channel band and the guard bandwidth of the network-side channel band is 40 KHz, so the offset is 40 KHz, and thus the low-frequency guard band of the network-side channel band offsets and then keeps consistent with a low-frequency guard band of a user equipment-side channel band.

Step S802: whether an interval between the initial position of the first physical resource block and a low-frequency initial position of the set frequency band is greater than or equal to a supported minimum guard bandwidth is determined, if yes, it is determined that the access condition is met, and if not, it is determined that the access condition is not met.

Based on the concept the same as the above method example, an example of the disclosure further provides a communication apparatus. The communication apparatus may have functions of user equipment 102 in the above method example and may be configured to perform steps performed by the user equipment 102 provided by the above example. The functions may be implemented through hardware or software or by executing the corresponding software through hardware. The hardware or software includes one or more modules corresponding to the above functions.

In a possible implementation, the communication apparatus 900 shown in FIG. 9 may serve as the user equipment 102 involved in the above method example and perform the steps performed by the user equipment 102 in the above method example.

The communication apparatus 900 includes a transceiving module 901.

The transceiving module 901 is configured to send user equipment capability information to a network device, where the user equipment capability information is used to indicate whether to support a first capability, the first capability is that a second guard bandwidth is also supported while a first guard bandwidth is supported for a first channel band within a set frequency band, and the first guard bandwidth is greater than the second guard bandwidth.

In some possible examples, the transceiving module 901 is further configured to:
send the user equipment capability information including a radio frequency parameter to the network device, where the radio frequency parameter includes an information field for indicating whether to support a transmission based on a supported narrow guard bandwidth, and the information field is used to indicate whether to support the first capability.

In some possible examples, the second guard bandwidth is equal to a guard bandwidth of a second channel band within a set frequency band, and the user equipment-side channel bandwidth is less than a network-side channel bandwidth.

In some possible examples, the first guard bandwidth and the second guard bandwidth are low-frequency guard bandwidths of the user equipment-side channel bandwidth.

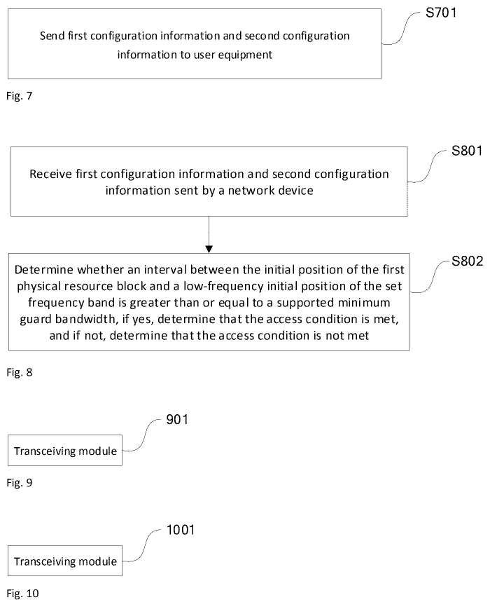

In a possible implementation, a communication apparatus 1000 shown in FIG. 10 may serve as user equipment 102 involved in the above method example and perform the steps performed by the user equipment 102 in the above method example.

The communication apparatus 1000 includes a transceiving module 1001.

The transceiving module 1001 is configured to receive first configuration information and second configuration information sent by a network device.

The first configuration information is used to indicate an offset, the offset is an offset of an initial position of a low-frequency guard band of a first channel band within a set frequency band, and an offset direction corresponding to the offset is a direction from a low frequency to a high frequency.

The second configuration information is used to indicate an initial position of a first physical resource block corresponding to the first channel band within the set frequency band, and the initial position is determined according to the offset.

In some possible examples, the offset is a first value, and the first value is an integer multiple of granularity of a channel raster.

In some possible examples, the offset is a second value, the second value is a difference value between a guard bandwidth of a second channel band and a guard bandwidth of the first channel band, a bandwidth of the first channel band is greater than a bandwidth of the second channel band, and the guard bandwidth of the first channel band is less than the guard bandwidth of the second channel band.

When the communication apparatus is the user equipment 102, its structure may further be shown in FIG. 11. FIG. 11 is a structural diagram of an apparatus 1100 for transceiving capability information or configuration information shown according to an example. For example, the apparatus 1100 may be a mobile phone, a computer, a digital broadcast terminal, a messaging device, a game console, a tablet device, a medical device, a fitness facility, a personal digital assistant and the like.

Referring to FIG. 11, the apparatus 1100 may include one or more components as follows: a processing component 1102, a memory 1104, a power component 1106, a multimedia component 1108, an audio component 1110, an input/output (I/O) interface 1112, a sensor component 1114 and a communication component 1116.

The processing component 1102 generally controls whole operation of the apparatus 1100, such as operations related to display, phone call, data communication, camera operation and recording operation. The processing component 1102 may include one or more processors 1120 for executing instructions so as to complete all or part of steps of the above method. Besides, the processing component 1102 may include one or more modules to facilitate interaction between the processing component 1102 and the other components. For example, the processing component 1102 may include a multimedia module so as to facilitate interaction between the multimedia component 1108 and the processing component 1102.

The memory 1104 is configured to store various types of data so as to support operations on the apparatus 1100. Examples of these data include instructions of any application program or method for operation on the apparatus 1100, contact person data, telephone directory data, messages, pictures, videos and the like. The memory 1104 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or a compact disc.

The power component 1106 provides power for various components of the apparatus 1100. The power component 1106 may include a power management system, one or more power sources, and other components related to power generation, management and distribution for the apparatus 1100.

The multimedia component 1108 includes a screen which provides an output interface between the apparatus 1100 and a user. In some examples, the screen may include a liquid crystal display (LCD) and a touch panel (TP). If the screen includes the touch panel, the screen may be implemented as a touch screen so as to receive an input signal from the user. The touch panel includes one or more touch sensors so as to sense touching, swiping and gestures on the touch panel. The touch sensor can not only sense a boundary of a touching or swiping action, but also detect duration and pressure related to touching or swiping operation. In some examples, the multimedia component 1108 includes a front camera and/or a back camera. When the apparatus 1100 is in an operation mode, such as a photographing mode or a video mode, the front camera and/or the back camera may receive external multimedia data. Each front camera and each back camera may be a fixed optical lens system or have a focal length and an optical zoom capability.

The audio component 1110 is configured to output and/or input an audio signal. For example, the audio component 1110 includes a microphone (MIC). When the apparatus 1100 is in the operation mode, such as a call mode, a recording mode and a voice recognition mode, the microphone is configured to receive an external audio signal. The received audio signal may be further stored in the memory 1104 or sent via the communication component 1116. In some examples, the audio component 1110 further includes a speaker for outputting the audio signal.

The I/O interface 1112 provides an interface between the processing component 1102 and a peripheral interface module, and the above peripheral interface module may be a keyboard, a click wheel, buttons and the like. These buttons may include but are not limited to: a home button, a volume button, a start button and a lock button.

The sensor component 1114 includes one or more sensors, configured to provide state evaluation of various aspects for the apparatus 1100. For example, the sensor component 1114 may detect a start/shut-down state of the apparatus 1100 and relative positioning of the components, for example, the components are a display and a keypad of the apparatus 1100. The sensor component 1114 may further detect location change of the apparatus 1100 or one component of the apparatus 1100, whether there is contact between a user and the apparatus 1100, azimuth or speed up/speed down of the apparatus 1100 and temperature change of the apparatus 1100. The sensor component 1114 may include a proximity sensor, configured to detect existence of a nearby object without any physical contact. The sensor component 1114 may further include an optical sensor, such as a CMOS or CCD image sensor, for use in imaging application. In some examples, the sensor component 1114 may further include an acceleration sensor, a gyroscope sensor, a magnetic sensor, a pressure sensor or a temperature sensor.

The communication component 1116 is configured to facilitate wired or wireless communication between the apparatus 1100 and other devices. The apparatus 1100 may be accessed to a wireless network based on a communication standard, such as WiFi, 4G or 5G, or their combination. In an example, the communication component 1116 receives a broadcast signal or related broadcast information from an external broadcast management system via a broadcast channel. In an example, the communication component 1116 further includes a near-field communication (NFC) module so as to facilitate short-range communication. For example, the NFC module may be implemented based on a radio frequency identification (RFID) technology, an infra-red data association (IrDA) technology, an ultra wide band (UWB) technology, a Bluetooth (BT) technology and other technologies.

In an example, the apparatus 1100 may be implemented by one or more than one application specific integrated circuit (ASIC), digital signal processor (DSP), digital signal processing device (DSPD), programmable logic device (PLD), field-programmable gate array (FPGA), controller, micro control unit, microprocessor or other electronic elements for executing the above method.

In an example, a non-transitory computer-readable storage medium including instructions is further provided, such as a memory 1104 including the instructions. The above instructions may be executed by a processor 1120 of an apparatus 1100 so as to complete the above method. For example, the non-transitory computer-readable storage medium may be an ROM, a random access memory (RAM), a CD-ROM, a magnetic tape, a floppy disk, an optical data storage device and the like.

Based on the concept the same as the above method example, an example of the disclosure further provides a communication apparatus. The communication apparatus may have functions of a network device 101 in the above method example and may be configured to perform steps performed by the network device 101 provided by the above example. The functions may be implemented through hardware or software or by executing the corresponding software through hardware. The hardware or software includes one or more modules corresponding to the above functions.

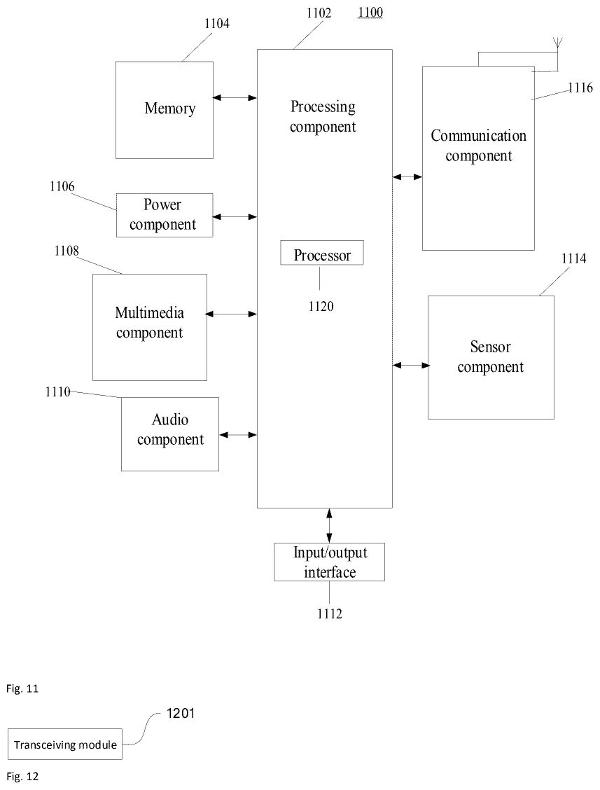

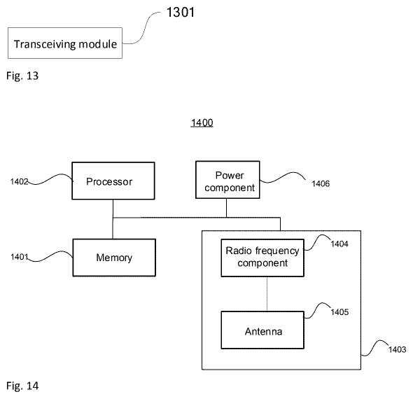

In a possible implementation, the communication apparatus 1200 shown in FIG. 12 may serve as the network device 101 involved in the above method example and execute the steps executed by the network device 101 in the above method example.

The communication apparatus 1200 shown in FIG. 12 includes a transceiving module 1201 configured to perform the steps performed by the network device 101 in the above method example.

The transceiving module 1201 is configured to receive user equipment capability information sent by user equipment, where the user equipment capability information is used to indicate whether to support a first capability, the first capability is that a second guard bandwidth is also supported while a first guard bandwidth is supported for a first channel band within a set frequency band, and the first guard bandwidth is greater than the second guard bandwidth.

In some possible examples, the transceiving module 1201 is further configured to:
receive the user equipment capability information including a radio frequency parameter sent by the user equipment, where the radio frequency parameter includes an information field for indicating whether to support a transmission based on a supported narrow guard bandwidth, and the information field is used to indicate whether to support the first capability.

In some possible examples, the second guard bandwidth is equal to a guard bandwidth of a second channel band within a set frequency band, and the user equipment-side channel bandwidth is less than a network-side channel bandwidth.

In some possible examples, the first guard bandwidth and the second guard bandwidth are low-frequency guard bandwidths of the user equipment-side channel bandwidth.

In a possible implementation, a communication apparatus 1300 shown in FIG. 13 may serve as a network device 101 involved in the above method example and perform the steps performed by the network device 101 in the above method example.

The communication apparatus 1300 shown in FIG. 13 includes a transceiving module 1301 configured to perform the steps performed by the network device 101 in the above method example.

The transceiving module 1301 is configured to send first configuration information and second configuration information to user equipment.

The first configuration information is used to indicate an offset, the offset is an offset of an initial position of a low-frequency guard band of a first channel band within a set frequency band, and an offset direction corresponding to the offset is a direction from a low frequency to a high frequency.

The second configuration information is used to indicate an initial position of a first physical resource block corresponding to the first channel band within the set frequency band, and the initial position is determined according to the offset.

In some possible examples, the offset is a first value, and the first value is an integer multiple of granularity of a channel raster.

In some possible examples, the transceiving module 1301 is further configured to:
not scheduling at least one of final physical resource blocks within the first channel band.

In some possible examples, the offset is a second value, the second value is a difference value between a guard bandwidth of a second channel band and a guard bandwidth of the first channel band, a bandwidth of the first channel band is greater than a bandwidth of the second channel band, and the guard bandwidth of the first channel band is less than the guard bandwidth of the second channel band.

When the communication apparatus is the network device 101, its structure may further be shown in FIG. 14. As shown in FIG. 14, the apparatus 1400 includes a memory 1401, a processor 1402, a transceiving component 1403 and a power component 1406. The memory 1401 is coupled with the processor 1402 and may be configured to store program and data needed for implementing the functions by the communication apparatus 1400. The processor 1402 is configured to support the communication apparatus 1400 for performing the corresponding functions in the above method, and the functions may be implemented by calling the program stored in the memory 1401. The transceiving component 1403 may be a wireless transceiver and may be configured to support the communication apparatus 1400 for receiving signaling and/or data and sending signaling and/or data through a wireless radio. The transceiving component 1403 may also be called a transceiving unit or a communication unit and may include a radio frequency component 1404 and one or more antennas 1405. The radio frequency component 1404 may be a remote radio unit (RRU), and may be specifically configured for transmission of a radio frequency signal and conversion between the radio frequency signal and a baseband signal. The one or more antennas 1405 may be specifically configured for radiation and receiving of the radio frequency signal.

When the communication apparatus 1400 needs to send data, the processor 1402 may perform baseband processing on the to-be-sent data, and then output a baseband signal to the radio unit, the radio unit performs radio frequency processing on the baseband signal and then send a radio frequency signal in a form of electromagnetic wave through the antenna. When data is sent to the communication apparatus 1400, the radio unit receives a radio frequency signal through the antenna, converts the radio frequency signal to a baseband signal and then outputs the baseband signal to the processor 1402, and the processor 1402 converts the baseband signal to data and processes the data.

Those skilled in the art will easily figure out other implementation solutions of the examples of the disclosure after considering the specification and practicing the disclosure disclosed here. The present application intends to cover any variation, use or adaptive change of the examples of the disclosure, and these variations, uses or adaptive changes conform to a general principle of the examples of the disclosure and include common general knowledge or conventional technical means in the technical field not disclosed by the disclosure. The specification and the examples are merely regarded as examples, and the true scope and spirit of the examples of the disclosure are indicated by the following claims.

It is to be understood that the examples of the disclosure are not limited to an accurate structure described above and shown in the accompanying drawings, and various modifications and changes can be made without departing from its scope. The scope of the examples of the disclosure is limited merely by the appended claims.

Those skilled in the art will easily figure out other implementation solutions of the examples of the disclosure after considering the specification and practicing the disclosure disclosed here. The present application intends to cover any variation, use or adaptive change of the examples of the disclosure, and these variations, uses or adaptive changes conform to a general principle of the examples of the disclosure and include common general knowledge or conventional technical means in the technical field not disclosed by the disclosure. The specification and the examples are merely regarded as examples, and the true scope and spirit of the examples of the disclosure are indicated by the following claims.

It is to be understood that the examples of the disclosure are not limited to an accurate structure described above and shown in the accompanying drawings, and various modifications and changes can be made without departing from its scope. The scope of the examples of the disclosure is limited merely by the appended claims.

### INDUSTRIAL APPLICABILITY

The user equipment capability information is reported to the network device by the user equipment, so as to indicate that the user equipment within the user equipment-side channel bandwidth may also support another smaller guard bandwidth while supporting a larger guard bandwidth, and dependence of the guard bandwidth on the difference value between the channel bandwidth and the transmission bandwidth is eliminated, so that a situation of a failure in accessing the user equipment caused by the fact that a guard bandwidth of the user equipment-side channel bandwidth is greater than the guard bandwidth of the network-side channel bandwidth when the user equipment accesses a network within the set frequency band is avoided.

1. A method for transceiving indication_information, performed by user equipment, wherein the indication information comprises user equipment capability information, the method comprises:
sending the user equipment capability information to a network device, wherein the user equipment capability information is used to indicate whether to support a first capability, the first capability is an ability of a user equipment-side channel bandwidth to support a first guard bandwidth and also to support a second guard bandwidth, and the first guard bandwidth is greater than the second guard bandwidth.

2. The method according to claim 1, wherein sending the user equipment capability information to the network device comprises:
sending the user equipment capability information comprising a radio frequency parameter to the network device, wherein the radio frequency parameter comprises an information field for indicating whether to support a transmission based on a supported narrow guard bandwidth, and the information field is used to indicate whether to support the first capability.

3. The method according to claim 1, wherein:
the second guard bandwidth is equal to a minimum guard bandwidth of a network-side channel bandwidth, and the user equipment-side channel bandwidth is less than the network-side channel bandwidth.

4. The method according to claim 19, wherein
the first guard bandwidth and the second guard bandwidth are low-frequency guard bandwidths of the user equipment-side channel bandwidth.

5. A method for transceiving indication information, performed by a network device, wherein the indication information comprises user equipment capability information, the method comprises:
receiving the user equipment capability information sent by user equipment, wherein the user equipment capability information is used to indicate whether to support a first capability, the first capability is an ability of a user equipment-side channel bandwidth to support a first guard bandwidth and also to support a second guard bandwidth, and the first guard bandwidth is greater than the second guard bandwidth.

6. The method according to claim 5, wherein receiving the user equipment capability information sent by the user equipment comprises:
receiving the user equipment capability information comprising a radio frequency parameter sent by the user equipment, wherein the radio frequency parameter comprises an information field for indicating whether to support a transmission based on a supported narrow guard bandwidth, and the information field is used to indicate whether to support the first capability.

7. The method according to claim 5, wherein:
the second guard bandwidth is equal to a minimum guard bandwidth of a network-side channel bandwidth, and the user equipment-side channel bandwidth is less than the network-side channel bandwidth.

8. The method according to claim 5, wherein
the first guard bandwidth and the second guard bandwidth are low-frequency guard bandwidths of the user equipment-side channel bandwidth.

9. The method for sending configuration information, performed by a network device, according to claim 5, wherein the indication information further comprises configuration information, the method further comprises:
sending first configuration information and second configuration information to the user equipment;
wherein the first configuration information is used to indicate an offset, the offset is an offset of an initial position of a low-frequency guard band of a network-side channel bandwidth, and an offset direction corresponding to the offset is a direction from a low frequency to a high frequency; and
the second configuration information is used to indicate an initial position of a first physical resource block corresponding to the network-side channel bandwidth within a set frequency band, and the initial position is determined according to the offset.

10. The method according to claim 9, wherein
the offset is a first value, and the first value is an integer multiple of granularity of a channel raster.

11. The method according to claim 10, wherein the method further comprises:
not scheduling at least one of final physical resource blocks within the network-side channel bandwidth.

12. The method according to claim 9, wherein
the offset is a second value, the second value is a difference value between a guard bandwidth of a user equipment-side channel bandwidth and a guard bandwidth of the network-side channel bandwidth, the network-side channel bandwidth is greater than the user equipment-side channel bandwidth, and the guard bandwidth of the network-side channel bandwidth is less than the guard bandwidth of the user equipment-side channel bandwidth.

13. The method according to claim 1, wherein the indication information further comprises configuration information, the method further comprises:
receiving first configuration information and second configuration information sent by the network device;
wherein the first configuration information is used to indicate an offset, the offset is an offset of an initial position of a low-frequency guard band of a network-side channel bandwidth, and an offset direction corresponding to the offset is a direction from a low frequency to a high frequency; and
the second configuration information is used to indicate an initial position of a first physical resource block corresponding to the network-side channel bandwidth within a set frequency band, and the initial position is determined according to the offset.

14. The method according to claim 13, wherein
the offset is a first value, and the first value is an integer multiple of granularity of a channel raster.

15. The method according to claim 13, wherein
the offset is a second value, the second value is a difference value between a guard bandwidth of a user equipment-side channel bandwidth and a guard bandwidth of the network-side channel bandwidth, the network-side channel bandwidth is greater than the user equipment-side channel bandwidth, and the guard bandwidth of the network-side channel bandwidth is less than the guard bandwidth of the user equipment-side channel bandwidth. pcm 16-19. (canceled)

20. A communication apparatus, comprising one or more processors and a memory, wherein
the memory is configured to store a computer program; and
the one or more processors are configured to execute the computer program so as to implement the following steps of:
sending the user equipment capability information to a network device, wherein the user equipment capability information is used to indicate whether to support a first capability, the first capability is an ability of a user equipment-side channel bandwidth to support a first guard bandwidth and also to support a second guard bandwidth, and the first guard bandwidth is greater than the second guard bandwidth.

21. A communication apparatus, comprising one or more processors and a memory, wherein
the memory is configured to store a computer program; and
the one or more processors are configured to execute the computer program so as to implement the method according to claim 5.

22-23. (canceled)

24 A non-transitory computer-readable storage medium, storing an instruction which causes, when called and executed on one or more computers, the one or more computers to perform the method according to claim 1.

25. A non-transitory computer-readable storage medium, storing an instruction which causes, when called and executed on one or more computers, the one or more computers to perform the method according to claim 5.

26-27. (canceled)

28. The communication apparatus according to claim 20, wherein the indication information further comprises configuration information, the one or more processors are configured to execute the computer program so as to further implement following steps of:
receiving first configuration information and second configuration information sent by the network device;
wherein the first configuration information is used to indicate an offset, the offset is an offset of an initial position of a low-frequency guard band of a network-side channel bandwidth, and an offset direction corresponding to the offset is a direction from a low frequency to a high frequency; and
the second configuration information is used to indicate an initial position of a first physical resource block corresponding to the network-side channel bandwidth within a set frequency band, and the initial position is determined according to the offset.
